(19) United States
(12) Patent Application Publication
(10) Pub. No.: US 2017/0184728 A1
(43) Pub. Date: Jun. 29, 2017

(54) SCINTILLATOR CONFIGURATIONS AND METHODS FOR FABRICATING THE SAME

(71) Applicant: General Electric Company, Schenectady, NY (US)

(72) Inventors: Sergei Ivanovich Dolinsky, Clifton park, NY (US); Ravindra Mohan Manjeshwar, Glenville, NY (US)

(21) Appl. No.: 14/982,247

(22) Filed: Dec. 29, 2015

(51) Int. Cl. G01T 1/20

(52) U.S. Cl. CPC G01T 1/2002; G01T 1/2018

(57) ABSTRACT

A scintillator block is presented. The scintillator block includes at least one scintillator having an isotropic volume. Furthermore, the scintillator block includes a laser-generated three-dimensional pattern positioned within the isotropic volume of the at least one scintillator, where the laser-generated three-dimensional pattern is configured to modify one or more optical properties within the isotropic volume of the at least one scintillator, and where the three-dimensional pattern varies along one or more of a depth, a width, and an angular orientation of the at least one scintillator.

### STATEMENT OF GOVERNMENT INTEREST

This invention was made with government support under grant 1R01CA163498-01A1 awarded by National Institute of Health. The government has certain rights in the invention.

### BACKGROUND

Embodiments of the present specification relate generally to scintillator-based radiation detectors, and more particularly to methods for fabricating improved scintillator configurations for use in radiation detectors.

Non-invasive imaging techniques are widely used in security screening, quality control, and medical diagnostic systems. Particularly, in medical imaging, non-invasive radiographic diagnostic imaging techniques such as X-ray transmission, computed tomography (CT), or positron emission tomography (PET) imaging allow for unobtrusive, convenient, and fast imaging of underlying tissues and organs. Additionally, certain non-invasive imaging techniques also allow for visualization of functional behavior such as biochemical or metabolic activities of organs and tissues within a patient.

By way of example, a PET system may be used to generate PET images that represent a distribution of positron-emitting nuclides within a patient's body. Generally, during PET imaging, a positron-emitting radionuclide may be introduced into the patient's body via a biologically active molecule. The radionuclide may undergo positron emission decay and emit a positron that travels in a tissue for a short distance. The emitted positron may subsequently interact with an electron. Typically, a positron-electron interaction results in annihilation, thus converting entire mass of the positron-electron pair into two gamma rays of 511 kilo electron Volt (keV) emitted in opposite directions along a line of response (LOR).

A conventional PET system includes a radiation detector having an array of detector elements for detecting the gamma rays emitted from the patient during the positron-electron annihilation. Particularly, conventional detector elements include a scintillator that converts an incident radiation into optical photons that are suitable for detection by the underlying photodetector. The photodetector, in turn, produces one or more electrical signals that are indicative of the energy of the incident radiation that is detected at a particular location by one or more of the detector elements. Subsequently, the electrical signals are collected, digitized, and transmitted to a data processing system for reconstruction of an image of a subject such as a patient.

Generally, quality of the acquired image may depend upon accurate localization of X-ray and/or gamma ray interactions in the scintillator. The localization of these interactions, in turn, may be determined by a response of the photodetector to the number of scintillation photons generated by the scintillator. Specific characteristics and configuration of the scintillator, thus, may significantly affect imaging performance of an imaging system. By way of example, scintillators of different thicknesses may be employed to impede incoming X-rays and high energy gamma rays with different efficiencies. However, an increase in thickness of the scintillator may also cause undesirable scattering, attenuation of scintillation photons, and/or degradation of a spatial resolution of the detector.

Accordingly, conventional imaging systems employ optically anisotropic scintillators that allow the scintillating photons to be preferentially transported to a desired location in a photodetector. Typically, the desired location corresponds to detector elements that are located proximate to a point of radiation interaction in the scintillator to aid in preserving the spatial resolution of the photodetector. Particularly, the conventional imaging systems rely on centroid detection techniques to locate the point of each gamma ray or X-ray interaction in the scintillator. However, an ability of the centroid detection techniques to preserve spatial information depends upon careful control of optical anisotropy of the scintillator. Additionally, the optical anisotropy of the scintillator also needs to be controlled for allowing sufficient light sharing amongst discrete detector elements, which in turn, aids in accurate centroid determination.

Conventionally, scintillators having desired optical anisotropy are fabricated by etching or machining deep grooves into a discrete scintillator block to form a grid pattern. Subsequently, the grooves are filled with a reflective medium to provide optical isolation between different regions of the scintillator. However, such grooves may only provide partial isolation, while also generating relatively large dead or insensitive areas to detecting the incident radiation.

Another fabrication approach entails packing discrete scintillator elements together with a reflective medium interposed therebetween. By way of example, conventional anisotropic scintillator blocks are assembled from discrete scintillator elements that are cut, polished, hand-wrapped in reflective tape, bundled, and/or glued together to form an anisotropic scintillator array. Such conventional fabrication approaches also entail attaching a light guide to the scintillator to optically couple the discrete scintillator elements. The light guide channels photons that are generated from the incident light towards the photodetector in a desired manner. However, use of the light guide and/or large number of sub-processes in the assembly of the anisotropic scintillator array results in increased complexity and/or high cost of production. Accordingly, conventional fabrication approaches are limited to production of simple rectilinear scintillators to limit complexity and cost. However, even in such approaches, uniformity of resulting scintillator blocks may differ owing to a difference in a skill and/or experience of a worker.

### BRIEF DESCRIPTION

In accordance with aspects of the present specification, a scintillator block is presented. The scintillator block includes at least one scintillator having an isotropic volume. Furthermore, the scintillator block includes a laser-generated three-dimensional pattern positioned within the isotropic volume of the at least one scintillator, where the laser-generated three-dimensional pattern is configured to modify one or more optical properties within the isotropic volume of the at least one scintillator, and where the three-dimensional pattern varies along one or more of a depth, a width, and an angular orientation of the at least one scintillator.

In accordance with another aspect of the present specification, an imaging system for imaging a subject is presented. The imaging system includes a radiation detector configured to acquire imaging data from a target volume in the subject. In addition, the imaging system includes a scintillator block operatively coupled to the radiation detector and including at least one scintillator having an isotropic volume and a laser-generated three-dimensional pattern positioned within the isotropic volume of the at least one scintillator, where the laser-generated three-dimensional pattern is configured to modify one or more optical properties within the isotropic volume of the at least one scintillator, and where the three-dimensional pattern varies along one or more of a depth, a width, and an angular orientation of the at least one scintillator.

In accordance with yet another aspect of the present specification, a method for fabricating a scintillator block is presented. The method includes providing at least one scintillator having an isotropic volume. Moreover, the method includes selecting a three-dimensional pattern that varies along one or more of a depth, a width, and an angular orientation corresponding to the at least one scintillator, where the three-dimensional pattern is configured to modify one or more optical properties corresponding to the isotropic volume of the at least one scintillator in a desired manner. The method also includes generating an anisotropic volume in the at least one scintillator by engraving the three-dimensional pattern in the isotropic volume using a pulsed laser, wherein the anisotropic volume is representative of a desired optical segmentation of the at least one scintillator.

### DRAWINGS

These and other features, aspects, and advantages of the present disclosure will become better understood when the following detailed description is read with reference to the accompanying drawings in which like characters represent like parts throughout the drawings, wherein:

FIG. 1 is a schematic diagram of an imaging system that includes an exemplary scintillator, in accordance with aspects of the present specification;

FIG. 2 is a schematic diagram illustrating a system for fabricating an exemplary scintillator, in accordance with aspects of the present specification;

FIG. 3 is a diagrammatic representation of an exemplary configuration of a scintillator block that may be fabricated using an embodiment of the system of FIG. 2, in accordance with aspects of the present specification;

FIG. 4 is a diagrammatic representation of an exemplary scintillator including a plurality of three-dimensional (3D) patterns, which vary along a depth of the scintillator, in accordance with aspects of the present specification;

FIG. 5 is a diagrammatic representation of an exemplary scintillator including a plurality of 3D patterns, which vary along a depth and a width of the scintillator, in accordance with aspects of the present specification;

FIG. 6 is a top view of the scintillator depicted in FIG. 5, in accordance with aspects of the present specification;

FIG. 7 is a diagrammatic representation of an exemplary scintillator that includes one or more 3D patterns generated on one or more parallel planes positioned along a width of the scintillator, in accordance with aspects of the present specification;

FIG. 8 is a diagrammatic representation of exemplary parallel planes that are positioned along a width of a scintillator such that the parallel planes include different patterns that vary along a depth and a width of a scintillator, in accordance with aspects of the present specification;

FIG. 9 is a diagrammatic representation of another exemplary patterned plane that varies along a depth of a scintillator and is generated on a parallel plane positioned along the depth and/or width of the scintillator, in accordance with aspects of the present specification;

FIG. 10 is a diagrammatic representation of an exemplary scintillator fabricated using a plurality of scintillator blocks including one or more 3D patterns, in accordance with aspects of the present specification; and

FIG. 11 is a diagrammatic representation of an exemplary scintillator that may be configured to provide enhanced light collection efficiency, in accordance with aspects of the present specification.

### DETAILED DESCRIPTION

The following description presents improved scintillator configurations for use in diagnostic imaging systems. Particularly, the embodiments described herein disclose a plurality of three-dimensional (3D) scintillator configurations that have optically segmented compartments to aid in accurately localizing scintillation events. Moreover, the present embodiments allow for improved light collection efficiency without use of any light guides. Additionally, the scintillator configurations presented hereinafter also provide accurate depth of interaction (DOI) information that may be used for facilitating accurate image reconstruction.

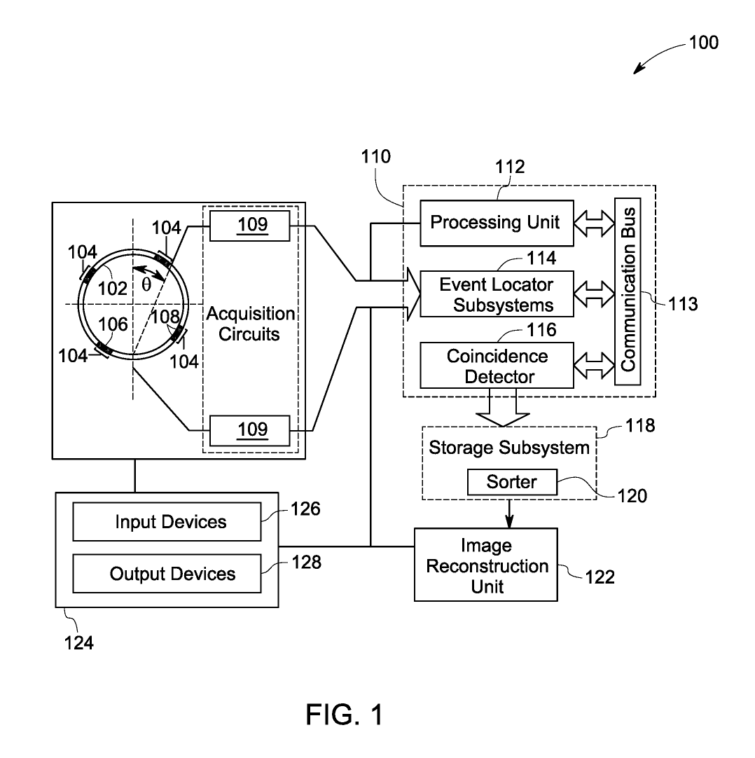

In the present specification, exemplary embodiments of the scintillator configurations are described in the context of a laser-engraved scintillator block for use in a PET imaging system. However, it will be appreciated that use of the present scintillator configurations in various other radiographic imaging applications and systems such as a single photon emission computed tomography (SPECT) imaging system, a photon-counting computed tomography (CT) imaging system, X-ray projection imaging systems and X-ray diffraction systems is also contemplated. An exemplary environment that is suitable for using various embodiments of the present scintillator configurations is described in the following sections with reference to FIG. 1.

FIG. 1 illustrates an exemplary imaging system 100 for imaging a target region of a subject such as a patient, an industrial object, and/or baggage. In one embodiment, the system 100 may correspond to a radiographic imaging system such as a positron emission tomography (PET) imaging system, a single photon emission computed tomography (SPECT) imaging system, photon-counting computed tomography (CT) imaging system, and/or a suitable X-ray imaging system. For clarity of description, an embodiment of the present system is described with reference to a PET imaging system.

In a presently contemplated configuration, the imaging system 100 is a PET imaging system. As previously noted, PET imaging entails a positron-electron interaction following introduction of a positron-emitting radionuclide into the patient's body. The positron-electron interaction results in annihilation, thus converting entire mass of the positron-electron pair into two 511-kilo electron Volt (keV) photons emitted in opposite directions along a line of response (LOR). In certain embodiments, the PET imaging system 100 may be configured to detect and correlate the emitted photons to functional information corresponding to the patient. Particularly, in one embodiment, the PET imaging system 100 may be configured to detect a coincidence event if both the emitted photons arrive and are detected during the same temporal window or gate. Additionally, the PET imaging system 100 may be configured to use the detected coincidence information for generating 2D and/or 3D PET images corresponding to the patient.

Accordingly, in one embodiment, the PET imaging system 100 may include a detector assembly 102 disposed about a patient bore (not shown). Specifically, the PET imaging system 100 may include multiple detector rings that may be spaced along a central axis of the PET imaging system 100 to form the detector ring assembly 102. The detector rings, in turn, may include a plurality of detector modules 104 that may be made, for example, from 6×6 arrays of individual Bismuth Germanate (BGO) or Lutetium oxyorthosilicate (LSO, LYSO) scintillator crystals. Generally, the detector modules 104 may be used to detect gamma radiation emitted from the patient. Additionally, the detector assembly 102 may be configured to convert the incident gamma ray and/or X-ray radiation to electrical signals, which in turn, may be used for generating diagnostic images of a desired region of the patient.

Specifically, in certain embodiments, each of the detector modules 104 may further include a scintillator 106 and one or more photosensors 108 such as vacuum photomultiplier tubes, silicon photomultiplers (SiPM), avalanche photodiodes (APD) or others, for detecting incident radiation. Particularly, the scintillator 106 may be configured to convert the incident gamma ray and/or X-ray radiation to optical scintillation photons. Further, the photosensors 108 may be configured to convert the scintillation photons into analog signals such as electrical signals. The electrical signals, in turn, may be used for reconstruction of one or more desired images of the subject.

In certain embodiments, the PET imaging system 100 may also include a set of acquisition circuits 109 that may be configured to receive the analog signals and generate corresponding digital signals. In one embodiment, the digital signals may be indicative of a 3D location and/or energy and/or time associated with a detected radiation event. The digital signals, thus, may be correlated with functional information, which may be used for accurate PET image reconstruction. However, accuracy of the PET image reconstruction depends upon determining an accurate 3D location corresponding to the detected radiation event.

Accordingly, in certain embodiments, the PET imaging system 100 may include a data acquisition subsystem (DAS) 110 configured to periodically sample the digital signals produced by the acquisition circuits 109. The DAS 110, in turn, may include a processing unit 112, which may be configured to control communications between different components of the PET imaging system 100. Particularly, in one embodiment, the processing unit 112 may be configured to communicate with different components of the PET imaging system 100 via a communication bus 113. In one embodiment, the communication bus 113, for example, may include electrical circuitry, electronic circuitry, a backplane bus, a wired communications network, and/or a wireless communications network. Additionally, the DAS 110 may also include one or more event locator circuits 114 that may be configured to assemble information corresponding to each valid radiation event into an event data packet. The event data packet, for example, may include a set of digital numbers that may accurately indicate a time and energy of the radiation event and a position of the detector crystals that detected the radiation event.

Additionally, in certain embodiments, the event locator circuits 114 may be configured to communicate the assembled event data packets to a coincidence detector 116 for determining coincidence events. Particularly, the coincidence detector 116 may be configured to identify coincidence event pairs if time and location markers in two event data packets are within pre-programmed and/or selected thresholds based on one or more desired criteria. By way of example, in one embodiment, the coincidence detector 116 may be configured to identify a coincidence event pair if time markers in two event data packets are within six nanoseconds of each other and if the corresponding locations lie on a straight line passing through a field of view (FOV) across a patient bore.

Further, in certain embodiments, the PET imaging system 100 may be configured to store the determined coincidence event pairs in a storage subsystem 118 that may be operatively coupled to the PET imaging system 100. The storage subsystem 118, for example, may include a sorter 120 that may be configured to sort the coincidence events. In one embodiment, for example, the sorter 120 may be configured to sort the coincidence events in a 3D projection plane format using a look-up table. Particularly, the sorter 120 may be configured to determine an order of the detected coincidence event data using one or more parameters such as radius and projection angles for efficient storage.

Moreover, in one embodiment, the processing unit 112 may be configured to process data corresponding to the coincidence events to determine corresponding time-of-flight (TOF) information. The TOF information may allow the PET imaging system 100 to estimate a point of origin of the electron-positron annihilation with enhanced precision, thus improving event localization. The event localization information, in turn, may be used to precisely locate one or more features of interest in reconstructed PET images.

Moreover, in one embodiment, the PET imaging system 100 may include an image reconstruction unit 122 that may be configured to use the improved event localization data to generate high resolution PET images corresponding to the target volume in the patient. In certain embodiments, the image reconstruction unit 122 may be an independent device that is communicatively coupled to the PET imaging system 100. However, in certain other embodiments, the image reconstruction unit 122 may be an integral part of the processing unit 112. Alternatively, the image reconstruction unit 122 may be absent and the processing unit 112 may be configured to perform one or more functions of the image reconstruction unit 122 such as reconstruction of the PET images.

Additionally, in one embodiment, the image reconstruction unit 122 may be configured to transmit the resulting high resolution PET images to an operator workstation 124. The operator workstation 124, for example, may include one or more input devices 126 and output devices 128. In one embodiment, the input devices 126, for example, may include a keyboard, mouse, control panel, a microphone, and/or other suitable devices. The input devices 126 may be configured to receive audio, video, and/or tactile user input prior to, during, and/or post a diagnostic PET scan of the subject. Further, the output devices 128, for example, include a display device, a printer, a plotter, a speaker, and/or other suitable output devices. In one embodiment, the image reconstruction unit 122 may be configured to reconstruct the high resolution PET images based on user input received from the input devices 126 and subsequently display the resulting PET images using the output devices 128 for further diagnosis and evaluation.

Generally, quality of PET images reconstructed by the image reconstruction unit 122 may depend upon accurate localization of the gamma or X-ray interactions in the scintillator 106. However, conventional imaging systems are often unable to accurately determine a location at which gamma or X-ray radiation interacts with an associated scintillator. Accordingly, conventional imaging systems often assign interactions that occur at different depths in scintillator crystals to a single location such as at the center of a front face of the scintillator crystals that experience the interactions. The inaccuracies in localizing the interactions in the crystals cause parallax errors, which in turn, lead to degradation of a spatial resolution of resulting PET images. More particularly, the conventional imaging systems may suffer from greater parallax error when the gamma or X-ray radiation that arise at a determined distance from the center of a FOV of the conventional imaging systems and obliquely enter into the scintillator crystals of the detectors. Consequently, in conventional imaging systems, the spatial resolution may be significantly degraded as the distance from the center of the FOV increases in a radial direction corresponding to the conventional imaging systems.

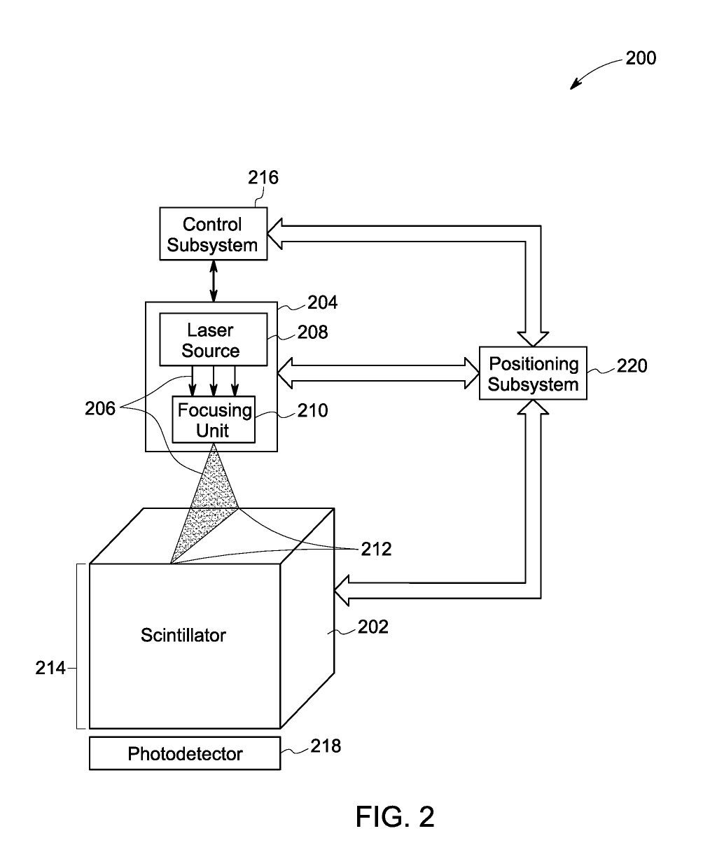

The shortcomings of such conventional imaging systems may be circumvented by use of the exemplary scintillator 106 of FIG. 1. In accordance with aspects of the present specification, the scintillator 106 may be configured to provide DOI measurement capabilities through enhanced localization of scintillation light relative to a laser-generated 3D pattern engraved within the scintillator and/or one or more of the outer surfaces in the scintillator 106. The 3D patterns may be specifically selected to allow for desired or optimal light collection, thereby enhancing the spatial resolution of the detector modules 104. An exemplary method for fabrication of different configurations of the present monolithic scintillator that provides DOI measurement capabilities will be described in greater detail with reference to FIG. 2.

FIG. 2 illustrates a system 200 for fabricating an exemplary scintillator 202 having one or more desired 3D patterns that provide DOI measurement capabilities. The scintillator so generated may be used in the PET imaging system 100 of FIG. 1. Particularly, the system 200 may be configured to generate one or more desired 3D patterns within the scintillator and/or one or more of the outer surfaces of the scintillator 202 with repeatable performance According to certain aspects of the present specification, the 3D patterns are selected to generate anisotropic optical segments in the scintillator 202 that aid in guiding and/or channeling the photons to a proximately disposed photosensor in a desired manner. Additionally, the 3D pattern may also allow for designs that are staggered or oriented in one or more directions, thereby allowing for generation of one or more distinctive features at different depths, widths, and/or orientations within the scintillator 202. The distinctive features aid in easier identification of individual layers of crystal arrays and corresponding spatial locations in the scintillator 202 that have experienced gamma or X-ray interactions, thus providing DOI information.

Accordingly, in one embodiment, the system 200 includes a laser generation subsystem 204 that may be configured to generate one or more laser beams 206. The laser beams 206 may be employed to modify one or more optical properties of the scintillator 202, thus generating a desired anisotropic region for channeling the scintillation light in a desired manner. In certain embodiments, the laser generation subsystem 204 may include a laser source 208 that may be configured to generate the laser beams 206 having one or more wavelengths. Further, the laser generation subsystem 204 may also include a focusing unit 210 operatively coupled to the laser source 208. In one embodiment, the focusing unit 210 may be configured to focus the laser beams 206 on to a focal spot or a focal volume 212 in the scintillator 202. Additionally, the focal volume 212, for example, may correspond to a selected region or volume of the scintillator 202 where it may be desirable to modify the optical properties of the scintillator 202.

In certain embodiments, the scintillator 202 may include glass, a single crystal, and/or a ceramic material having desired optical properties. Particularly, in one embodiment, the scintillator 202 may include at least one isotropic volume 214 where optical properties of a constituent material of the scintillator 202 are constant. In certain embodiments, the laser source 208 may be configured to modify the isotropic volume 214 via use of the laser beams 206. Specifically, the laser source 208 may be configured to focus the laser beams 206 on the isotropic volume 214. The laser beams 206, thus focused, may be configured to ablate scintillator material at the isotropic volume 214 in the scintillator 202 to generate one or more desired 3D patterns. Generation of the 3D patterns results in modification of one or more optical properties of the isotropic volume 214 of the scintillator 202, thereby creating at least one anisotropic volume in the scintillator 202.

Moreover, in some embodiments, the system 200 may include a control subsystem 216 that may be configured to provide control signals for generation of the desired 3D patterns. Accordingly, in one embodiment, the control subsystem 216 may include devices such as one or more application-specific processors, graphical processing units, digital signal processors, microcomputers, microcontrollers, Application Specific Integrated Circuits (ASICs), Field Programmable Gate Arrays (FPGAs), Programmable Logic Arrays (PLAs), and/or other suitable control and/or processing devices.

Additionally, in one embodiment, the control subsystem 216 may be communicatively coupled to the laser source 208 and/or the focusing unit 210. Moreover, the control subsystem 216 may be configured to select one or more 3D patterns that are suitable for generation of a desired anisotropy in the isotropic volume 214. It may be noted that the selection of the one or more 3D patterns may be automatic and/or based on user input. Generating the desired anisotropy via use of the selected 3D patterns, in turn, may aid in channeling scintillation photons generated from incident radiation to a photodetector 218 in a desired manner. In accordance with aspects of the present specification, channeling the photons to a photodetector 218 in the desired manner aids in identifying the origin of the photons towards the photodetector 218. Accurate identification of the origin of scintillation photons via use of the 3D patterns, thus, allows for accurate decoding of the incident radiation and subsequent image reconstruction.

Further, in one embodiment, the system 200 may include a positioning subsystem 220 configured to aid in generation of the desired 3D patterns. In certain embodiments, the positioning subsystem 220 may be operatively coupled to the control subsystem 216, the laser source 208, and/or the scintillator 202. Additionally, the positioning subsystem 220 may be configured to move the laser source 208 and/or the scintillator 202 in one or more directions to aid in the generation of the desired 3D patterns at one or more selected locations in the scintillator 202. Particularly, in one embodiment, the positioning subsystem 220 may be configured to receive one or more control signals that cause movement of the laser source 208 to a desired position relative to the isotropic volume 214 in the scintillator 202. Alternatively, the control signals may cause movement of the scintillator 202, and in turn, the isotropic volume 214 relative to the laser beams 206. Thus, the positioning subsystem 220 may be configured to move the laser source 208 and/or the scintillator 202 based on the control signals to aid in focusing the laser beams 206 over the isotropic volume 214.

As previously noted, the laser beams 206 may be used to modify one or more optical properties of the scintillator 202 to generate the desired 3D patterns. These patterns modify optical properties corresponding to the isotropic volume 214 in the scintillator 202, in turn, thereby resulting in anisotropic properties in the isotropic volume 214. In one embodiment, modifying the optical properties, for example, may include modifying a crystal structure of the scintillator 202. In another embodiment, the optical properties may be modified by generating micro-voids corresponding to a desired 3D pattern within the scintillator 202. In certain further embodiments, modifying the optical properties may also include creating local crystal domains in the isotropic volume 214 that have orientations that are different from orientations of other crystal domains in the scintillator 202. Furthermore, in yet another embodiment, modifying the optical properties may include creating localized crystalline regions in otherwise non-crystalline materials such as glass. In addition, modifying the optical properties, for example, may also include modifying an index of refraction, an optical absorption, and/or photon scattering properties at the focal volume 212.

In certain embodiments, the optical properties at the focal volume 212 may be modified using ultrafast pulses of the laser beams 206. Some examples of the ultrafast pulses of the laser beams 206 may include nanosecond pulses, picosecond (less than about 10 picoseconds) pulses, and/or femtosecond (10⁻¹⁵ second) pulses. However, an interaction of the laser beams 206 at the focal volume 212 in the scintillator 202 typically corresponds to a non-resonant, non-linear, multi-photon interaction. Specifically, in certain embodiments, the interaction between the focal volume 212 generated by the laser beams 206 and scintillator may be independent of a wavelength of the laser beams 206 generated by the laser source 208, thus exhibiting non-resonance. Accordingly, the same laser source 208 may be used for generating the desired 3D patterns in different types of constituent materials corresponding to the scintillator 202.

Further, it may be noted that a strength of the interaction between the laser beams 206 and the scintillator 202 increases non-linearly as the intensity of the laser beams 206 is raised to a desired power. Thus, a maximum strength of the interaction between the laser beams 206 and the scintillator 202 may be experienced in a region of the scintillator 202 that may be smaller than the focal volume 212. Moreover, in one example, the interaction between the laser beams 206 and the scintillator 202 may occur only when a determined threshold is exceeded. In another example, when employing tightly focused laser beams 206, the interaction between the laser beams 206 and the scintillator 202 may occur only in the center of the focal volume 212 to provide tight control over resulting optical anisotropy in the scintillator 202.

Particularly, in certain embodiments, the non-linear and multi-photon nature of the interaction between the laser beams 206 and the scintillator 202 may allow for generation of distinctive features corresponding to the desired 3D patterns that may be smaller than the focal volume 212. Moreover, use of the laser beams 206 enables optical properties corresponding to desired regions in the focal volume 212 to be modified without transferring excessive heat to the surrounding material in the scintillator 202. Specifically, use of the ultrafast pulses of the laser beams 206 may cause direct transition of a solid scintillator material located at the focal volume 212 to plasma. Consequently, such a direct transition of the solid scintillator material to plasma results in transfer of only a small amount of heat to material surrounding the focal volume 212, thus preventing cracks or other such damage to the scintillator 202.

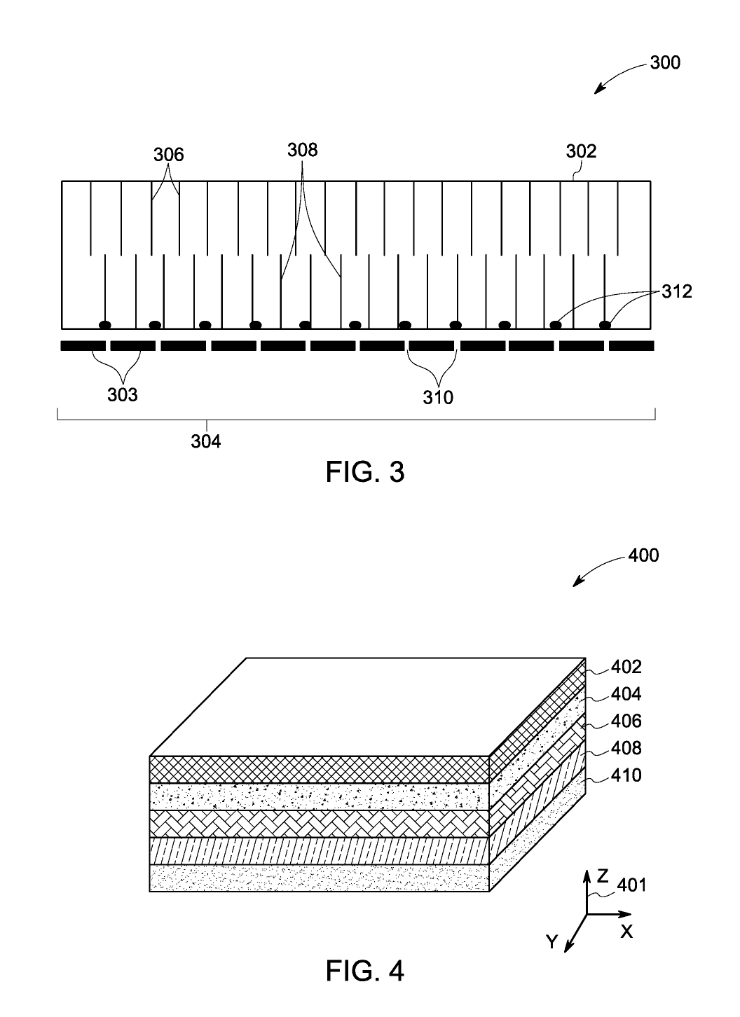

Use of the laser beams 206, thus, may allow for generation of distinctive and/or identifiable features for fabricating complex yet repeatable 3D patterns in the scintillator 202. As previously noted, the complex 3D patterns may be used for accurately localizing scintillation events in all three dimensions of the scintillator 202. Particularly, the PET imaging system 100 (see FIG. 1) may allow for generation of specific 3D patterns that aid in easier identification of layers of crystal arrays and corresponding locations in the scintillator 202 that have experienced gamma or X-ray interactions, thus providing accurate DOI information. Availability of accurate DOI information facilitates correction of parallax errors, thus allowing the detector 104 (see FIG. 1) to simultaneously provide high spatial resolution and high sensitivity for optimal image reconstruction. Certain exemplary 3D patterns that may be generated over one or more inner and/or outer surfaces of a scintillator block for providing DOI information will be described in greater detail with reference to FIGS. 3-11.

FIG. 3 illustrates a diagrammatic representation 300 of an exemplary configuration of a scintillator block 302 that may be fabricated using an embodiment of the system 200 of FIG. 2. In one embodiment, the scintillator block 302 may correspond to a monolithic scintillator block having a plurality of 3D patterns. The 3D patterns, for example, may be generated in one or more layers in the scintillator block 302 using a focused high intensity laser source (not shown in FIG. 3) such as the laser source 208 of FIG. 2.

In certain embodiments, the laser source may be configured to generate one or more desired 3D patterns on one or more surfaces of the scintillator block 302. As previously noted, the 3D patterns aid in generating at least one optically anisotropic volume. The anisotropic volume, in turn, may aid in channeling scintillation photons generated from the incident radiation to an underlying photosensor array 304 in a desired manner to control light sharing between different regions of the scintillator block 302 and/or maximize a corresponding light collection efficiency. Additionally, the desired 3D patterns may be selected to aid in easier identification of layers in the scintillator block 302 and corresponding spatial locations in the scintillator block 302 that have experienced gamma or X-ray interactions. Identification of the spatial locations in the scintillator block 302 that experience the gamma or X-ray interactions may provide DOI information. The DOI information, in turn, may be used to correct for parallax errors in detected gamma ray or X-ray radiation, thus aiding in generation of high sensitivity and/or high resolution images.

According to certain aspects of the present specification, a focused high intensity laser beam may be used to ablate the monolithic scintillator block 302 to generate a desired 3D pattern. Particularly, in one embodiment, the focused high intensity laser beam may be used to ablate the monolithic scintillator block 302 to generate a first layer of 306 and a second layer 308 of “pixels.” In certain embodiments, each of the first layer 306 and the second layer 308 may have a thickness of about 2.5 millimeters (mm). Also, in certain embodiments, the 3D pattern may correspond to a linear design where each of the pixels in the first layer 306 and the second layer 308 is positioned in a linear design. Alternatively, each of the layers 306 and 308 may be shifted in one or more directions by a fraction of a desired crystal dimension, thereby resulting in a staggered design of the 3D pattern.

Particularly, in the embodiment depicted in FIG. 3, the 3D pattern may be generated such that the first layer 306 and the second layer 308 are positioned at different spatial depths. However, in certain embodiments, the 3D pattern may include a staggered design where the first layer 306 of pixels may be interspersed between the second layer 308 of pixels. The staggered design aids in identifying a layer where X-ray and/or gamma ray interactions occur within the scintillator block 302 and corresponding DOI information. Availability of accurate DOI information facilitates optimal reconstruction of an image of the subject. Use of the laser/laser source, thus may allow for elimination of conventional multi-stage fabrication that includes time-consuming steps such as cutting, polishing, gluing, and aligning different scintillator blocks. Elimination of the conventional multi-stage fabrication simplifies large-scale and repeatable production of the scintillator block 302 without incurring substantial costs. The resulting scintillator block 302, thus, may be employed for optimal light collection in a CT, PET, and/or SPECT imaging system.

Generally, packaging of photosensors 303 for use in a diagnostic imaging system may result in dead or light insensitive areas 310 located between two photosensors 303 in the photosensor array 304. Conventional detectors employ an additional light guide and/or media that may be shaped and/or adapted to reflect light to a photo-sensitive area of the photosensor array 304. However, use of light guides and/or additional media significantly increases complexity and/or cost of the diagnostic imaging system. Moreover, use of the light guides and/or additional media may also result in inefficient channeling of the photons to the photosensor array 304. The inefficient channeling of the photons may lead to signal degradation, in turn, leading to sub-optimal image reconstruction.

Accordingly, in one embodiment, 3D patterns that include voids or special patterns 312 on one or more inner and/or outer surfaces of the scintillator block 302 to reflect incident light away from the dead areas 310 and towards photosensitive portions of the photosensor array 304 may be employed. Particularly, the 3D pattern may be selected to match the dead areas 310 of the photosensor array 304, thereby enhancing a scintillator light collection efficiency. In certain embodiments, use of a pulse laser allows for generation of complex 3D patterns that aid in efficient channeling of the incident light in different scintillator configurations while circumventing the need for complicated and time-consuming cutting and polishing steps. Additionally, in certain embodiments, generation of the 3D patterns on the scintillator block 302 may eliminate a need for a light guide and/or additional media for optimal light collection. However, use of an additional light guide (not shown) in conjunction with the 3D pattern is also contemplated in certain scenarios for further enhancing light collection efficiency of the photosensor array 304.

FIG. 4 illustrates a diagrammatic representation of an exemplary monolithic scintillator 400 including a plurality of three-dimensional (3D) patterns, which vary along a depth of the scintillator 400. In the present example, the monolithic scintillator block 400 is shown as including a plurality of layers with different 3D patterns. In one embodiment, a 3D pattern variable along a Z-direction 401 or depth of the scintillator block 400 may be generated on the scintillator 400. Particularly, a plurality of layers 402, 404, 406, 408, and 410 in the scintillator 400 may be patterned via use of a high intensity pulse laser. In accordance with aspects of the present specification, one or more of the layers 402, 404, 406, 408, and 410 may include the same or different 3D patterns generated using an embodiment of the system 200 of FIG. 2.

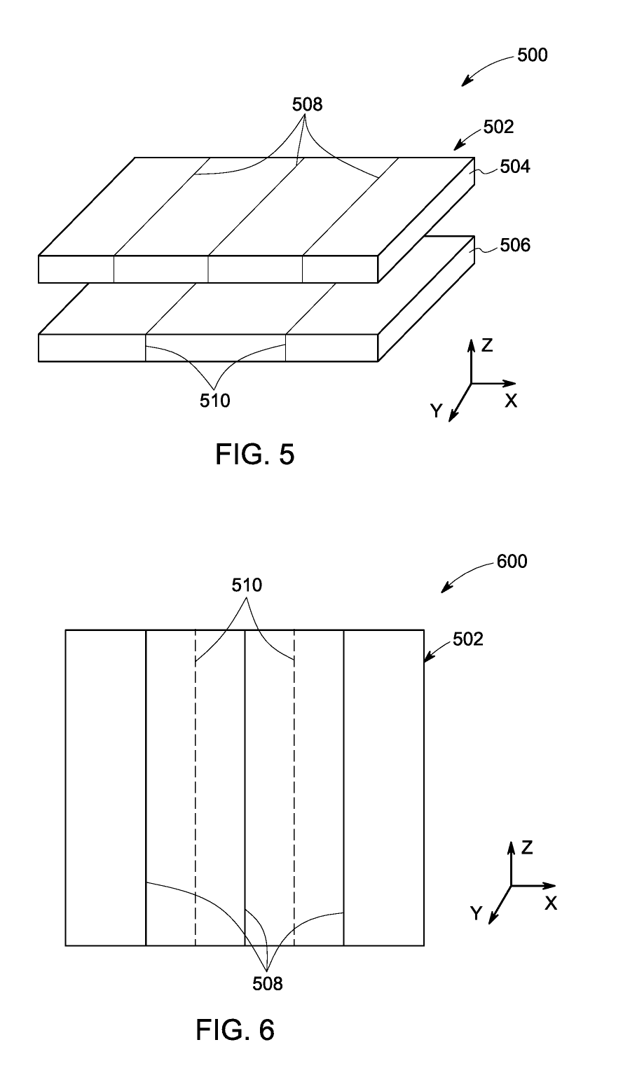

Similarly, FIG. 5 illustrates a diagrammatic representation 500 of an exemplary scintillator 502 including a plurality of 3D patterns, which vary along a depth and a width of the scintillator 502. In the embodiment depicted in FIG. 5, the scintillator 502 includes a first layer 504 of a crystal array and a second layer 506 of a crystal array. Further, in certain embodiments, the first layer 504 and the second layer 506 may be patterned via use of a high intensity pulse laser. Additionally, 3D patterns may be generated on one or more parallel planes in the first layer 504 and the second layer 506, where the parallel planes may be staggered in one or more directions relative to neighboring layers. Specifically, in one example, the first layer 504 may include three parallel planes 508, whereas the second layer 506 may include two parallel planes 510.

Further, FIG. 6 illustrates a top view 600 of the exemplary scintillator 502 depicted in FIG. 5. Particularly, FIG. 6 depicts the relative positions of the parallel planes 508 and 510 of FIG. 5 generated in the first layer 504 and the second layer 506, respectively. Use of desired 3D patterns may allow for a greater control over a spatial distribution of light to photosensors (not shown in FIGS. 5-6). Particularly, distinctive features of the 3D patterns may aid in accurate identification of a location (for example, via centroid and/or width of light distribution) of an X-ray or gamma ray interaction in the scintillator 502.

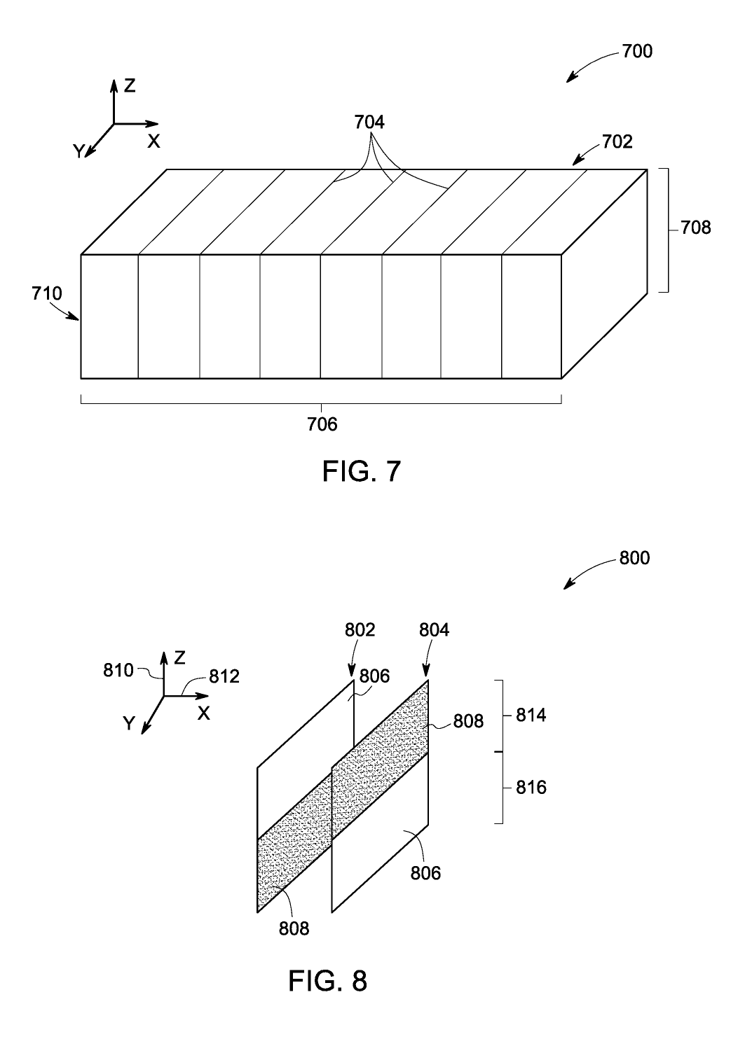

Additionally, FIG. 7 also illustrates a diagrammatic representation 700 of another exemplary scintillator 702 that includes one or more 3D patterns generated on one or more parallel planes 704. In the embodiment of FIG. 7, the parallel planes are positioned along a width 706 of the scintillator 702. Additionally, one or more desired 3D patterns may be generated in one or more layers of crystal arrays that vary along a depth 708 of the scintillator 702. Particularly, in one embodiment, different 3D patterns may be generated on different surfaces along the width 706 of the scintillator 702 even though an overall depth/height 706 of the scintillator 702 may remain constant. Additionally, the 3D patterns may be generated such that the 3D patterns include regions having high reflectivity interspersed with regions having low reflectivity regions after every few indentations in the scintillator 702.

For clarity, FIG. 7 depicts only a single layer 710 of crystal arrays corresponding to the scintillator 702. However, in other embodiments, the scintillator 702 may include additional layers of crystal arrays. Moreover, the 3D pattern may be generated in one or more parallel planes 704 that may intersect the layer 710 and other layers, if present, in the scintillator 702. Additionally, in one embodiment, each of the parallel planes 704 may stagger along one or more directions corresponding to the layer 710 and/or other layers in the scintillator 702.

Further, FIG. 8 depicts a diagrammatic representation 800 of exemplary parallel planes 802 and 804 that are positioned along a width of a scintillator such as the scintillator 700 of FIG. 7. Particularly, in one embodiment, the parallel planes 802 and 804 include different patterns 806 and 808 that vary along a depth 810 and a width 812 of the scintillator. In one example, the patterns 806 and 808 vary along the depth 810 such that a region of high reflectivity 816 is aligned with a region of low reflectivity 814 in an adjacent layer of crystal arrays in the scintillator.

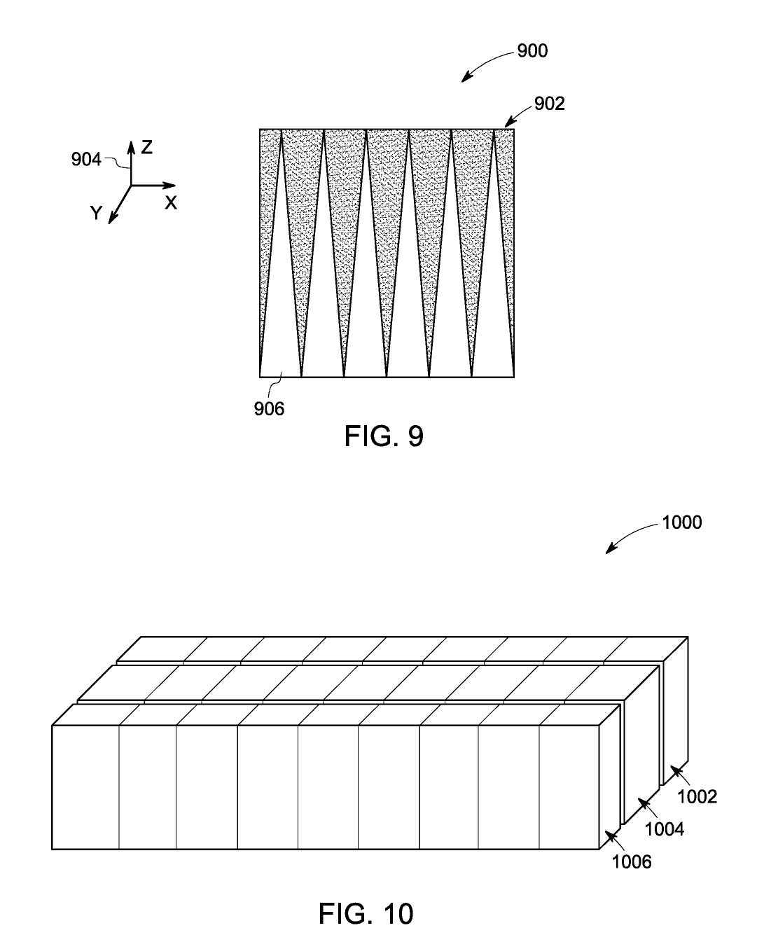

Moreover, FIG. 9 depicts another exemplary patterned plane 900 that is generated inside a scintillator such as the scintillator 700 of FIG. 7. In particular, a pattern 906 may be generated on a plane 902 (patterned plane 902) that is positioned along a depth 904 or Z direction of a scintillator. However, in an alternative embodiment, the exemplary pattern 906 may be generated on a plane that is aligned along a width of the scintillator. In FIG. 9, the 3D pattern 906 may be generated by ablating the scintillator using an ultrafast pulse laser to generate a continuous zig-zag pattern 906 of the patterned plane 902 corresponding to the scintillator. In one embodiment, the zig-zag pattern 906 may be generated on the patterned plane 902 in one or more directions, where the zig-zag pattern 906 varies along the depth 904 of the scintillator.

Variation of the 3D pattern 906 along the depth 904 of the scintillator aids in modifying a width of spatial distribution of scintillation light along a photosensor array (not shown in FIG. 9) in an efficient manner. Efficient propagation and/or distribution of the light to the photosensor array aids in detection of accurate signals that may subsequently be used for accurate localization of scintillation events and subsequent image reconstruction.

Furthermore, in certain scenarios, it may be desirable to use a large scintillator and/or to generate more intricate 3D patterns in the scintillators. FIG. 10 illustrates a diagrammatic representation of an exemplary scintillator block 1000 fabricated using a plurality of scintillator crystals. Generally, producing smaller scintillator crystals entails simpler manufacturing processes and lower cost as compared to producing one large monolithic scintillator block. Accordingly, in one embodiment, two or more monolithic scintillators 1002, 1004, and 1006 may be combined to form a scintillator block 1000 of a desired size. In one embodiment, each of the monolithic scintillators 1002, 1004, and 1006 may be patterned using an ultrafast pulse laser, as described with reference to FIG. 2. Particularly, each of the monolithic scintillators 1002, 1004, and 1006 may be ablated via use of the pulse laser to generate one or more desired 3D patterns such as the staggered and/or zig-zag patterns illustrated in FIGS. 4-9.

Alternatively, in certain embodiments, one or more of the monolithic scintillators 1002, 1004, and 1006 may be patterned and subsequently assembled into the scintillator block 1000 using conventional fabrication techniques. By way of example, one or more of the monolithic scintillator blocks 1002, 1004, and 1006 may undergo cutting, etching, and/or polishing to generate the desired 3D patterns in the scintillator block 1000. However, in some embodiments, one or more of the monolithic scintillators 1002, 1004, and 1006 may be patterned and subsequently assembled using a combination of fabrication steps described with reference to the laser-based system 200 of FIG. 2 and conventional fabrication methods.

By way of example, in one embodiment, the desired 3D patterns may be engraved into one or more of the scintillators 1002, 1004, and 1006 using pulse laser and/or conventional cutting and polishing steps. The 3D pattern may be selected such that the engraved 3D pattern limits distribution of the scintillation light to one row, column, and/or a distinctive region of the crystal arrays. Subsequently, the patterned scintillators 1002, 1004, and/or 1006 may be assembled to form the scintillator 1000. In certain embodiments, the scintillator block 1000 may include better optical segmentation, thereby providing easier identification of different regions of the scintillator 1000 that experience X-ray or gamma interaction during imaging at high a count rate. Moreover, the high count rate and enhanced optical segmentation provide significant improvement in detection efficiency over conventional imaging systems.

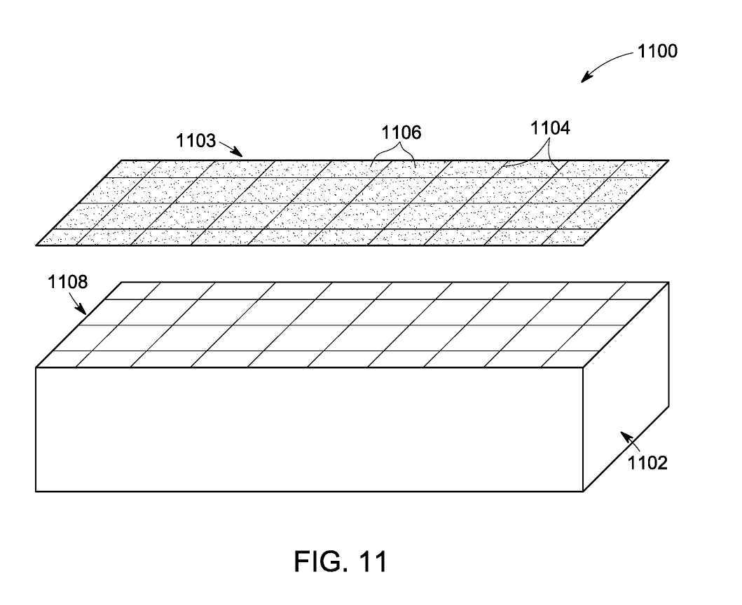

Further, FIG. 11 illustrates a diagrammatic representation 1100 of an exemplary scintillator 1102 that may be configured to provide enhanced light collection efficiency. As previously noted, a photosensor array 1103 may include one or more dead areas 1104 around individual photosensors 1106 due to packaging. As the dead areas 1104 are light insensitive, scintillation light impinging on the dead areas 1104 may be lost, thereby degrading a performance of an associated detector.

Conventionally, light guides are used to eliminate loss of the scintillation light owing to the dead areas 1104 in the photosensor array 1103. However, such conventional remedies are expensive, time-consuming, and/or entail use of additional parts. In accordance with aspects of the present specification, design of the scintillator 1102 may be selected such that the effect of dead areas 1104 between the photosensors 1106 in an imaging device is minimized Specifically, in one embodiment, an ultrafast laser source such as the laser generation subsystem 204 of FIG. 2 may be used to generate an additional pattern 1108 on an external surface of the scintillator 1102, where the pattern 1108 matches a configuration of the photosensors 1106 in the photosensor array. Such pattern matching redirects scintillation light from the dead areas 1104 towards active areas of the photosensors 1106, thus improving light collection and a detection efficiency.

Embodiments of the present systems and methods present enhanced scintillator configurations that provide DOI capabilities. In particular, the scintillators include 3D patterns that are generated within a monolithic scintillator via use of a focused high intensity laser. Use of the pulse laser allows for generation of extremely small, repeatable, and complex 3D patterns in the scintillator, which in turn, aids in fabrication of detectors having small scintillator pixel size (about 1.5-2 millimeter), high packing fraction, high sensitivity, and/or high resolution. Moreover, use of the laser-generated 3D patterns also eliminates a need for additional light guides, thus curtailing equipment and/or operational costs.

Furthermore, the 3D patterns may be selected to vary along a height, depth, and/or different orientations corresponding to the scintillator block. Also, the 3D patterns are employed to generate desired optical anisotropy in a region of interest via use of the pulse laser. Fabrication of a scintillator having the desired optical anisotropy creates desired optical segments in the scintillator. The optical segments, in turn, aid in channeling optical photons from the scintillator to the photosensors via the 3D patterns in a desired manner to maximize detection efficiency. Additionally, the 3D patterns also allow for measurement of an origin of scintillation light, thus providing accurate DOI information that may be used in reconstructing accurate and clinically useful images.

Although, only a few scintillator configurations have been described herein, it may be noted that other 3D configurations may also be employed. By way of example, the 3D patterns may not be limited to rectangular configurations, constant cross-sectional shapes, and/or sizes. For example, the 3D patterns may include triangular, trapezoidal, hexagonal, and/or curvilinear patterns. Alternatively, the 3D patterns may define a combination of configurations, such as octagons and squares. Additionally, it may be noted that the embodiments described herein with reference to scintillators may also be used for fabrication of light guides, optical sensors window, and the like.

It may be noted that although specific features of various embodiments of the present systems and methods may be shown in and/or described with respect to only certain drawings and not in others, this is for convenience only. It is to be understood that the described features, structures, and/or characteristics may be combined and/or used interchangeably in any suitable manner in the various embodiments, for example, to construct additional assemblies and techniques.

While only certain features of the present disclosure have been illustrated and described herein, many modifications and changes will occur to those skilled in the art. It is, therefore, to be understood that the appended claims are intended to cover all such modifications and changes as fall within the true spirit of the present disclosure.

1. A scintillator block, comprising:
at least one scintillator having an isotropic volume; and
a laser-generated three-dimensional pattern positioned within the isotropic volume of the at least one scintillator, wherein the laser-generated three-dimensional pattern is configured to modify one or more optical properties within the isotropic volume of the at least one scintillator, and
wherein the three-dimensional pattern varies along one or more of a depth, a width, and an angular orientation of the at least one scintillator.

2. The scintillator block of claim 1, wherein the laser-generated three dimensional pattern is configured to provide location information corresponding to an origin of scintillation events within the at least one scintillator based on light transport properties of the at least one scintillator.

3. The scintillator block of claim 1, wherein the at least one scintillator comprises a plurality of monolithic scintillators.

4. The scintillator block of claim 1, wherein the three-dimensional pattern is engraved along two or more parallel planes of the at least one scintillator.

5. The scintillator block of claim 1, wherein the three-dimensional pattern comprises a plurality of layers of laser-generated three-dimensional patterns engraved along two or more parallel planes of the at least one scintillator.

6. The scintillator block of claim 1, wherein two or more parallel planes of the at least one scintillator are positioned in a staggered arrangement in one or more directions.

7. The scintillator block of claim 1, wherein two or more parallel planes in the at least one scintillator are positioned such that the two or more parallel planes are staggered in one or more directions relative to other planes of another scintillator.

8. The scintillator block of claim 1, wherein the at least one scintillator further comprises a mechanically-generated three-dimensional pattern.

9. The scintillator block of claim 1, wherein the laser-generated three-dimensional pattern corresponds to a depth variable pattern configured to modify a width of spatial distribution of scintillation light emitted from the at least one scintillator.

10. The scintillator block of claim 1, wherein the laser-generated three-dimensional pattern comprises one or more distinctive features located at a determined depth, a determined width, a determined orientation, or combinations thereof, in the at least one scintillator.

11. The scintillator block of claim 10, wherein the one or more distinctive features are configured to modify a spatial distribution of scintillation light emitted from the at least one scintillator in a desired manner.

12. The scintillator block of claim 11, wherein the spatial distribution of light is configured to provide information corresponding to a depth of interaction of scintillation light in the at least one scintillator, identify a three-dimensional spatial location at which the scintillation light is incident on the at least one scintillator, or a combination thereof.

13. The scintillator block of claim 1, further comprising an additional pattern engraved on a desired layer of the at least one scintillator, wherein the additional pattern is configured to redirect scintillation light away from one or more light insensitive areas corresponding to one or more photosensors and towards one or more active areas corresponding to the one or more photosensors.

14. An imaging system for imaging a subject, comprising:
a radiation detector configured to acquire imaging data from a target volume in the subject;
a scintillator block operatively coupled to the radiation detector and comprising:
at least one scintillator having an isotropic volume; and
a laser-generated three-dimensional pattern positioned within the isotropic volume of the at least one scintillator, wherein the laser-generated three-dimensional pattern is configured to modify one or more optical properties within the isotropic volume of the at least one scintillator, and
wherein the three-dimensional pattern varies along one or more of a depth, a width, and an angular orientation of the at least one scintillator.

15. The imaging system of claim 14, wherein the imaging system is a positron emission tomography imaging system, an X-ray projection imaging system, an X-ray diffraction system, a computed tomography imaging system, a single positron emission computed tomography imaging system, or combinations thereof.

16. The imaging system of claim 14, wherein the laser-generated three-dimensional pattern is configured to provide location information corresponding to an origin of scintillation events within the at least one scintillator based on light transport properties of the at least one scintillator.

17. The imaging system of claim 14, further comprising a display configured to visualize one or more images generated by the imaging system corresponding to the subject.

18. A method for fabricating a scintillator block, comprising:
providing at least one scintillator having an isotropic volume;
selecting a three-dimensional pattern that varies along one or more of a depth, a width, and an angular orientation corresponding to the at least one scintillator, wherein the three-dimensional pattern is configured to modify one or more optical properties corresponding to the isotropic volume of the at least one scintillator in a desired manner; and
generating an anisotropic volume in the at least one scintillator by engraving the three-dimensional pattern in the isotropic volume using a pulsed laser, wherein the anisotropic volume is representative of a desired optical segmentation of the at least one scintillator.

19. The method of claim 18, wherein selecting the laser-generated three-dimensional pattern comprises identifying a laser-generated three-dimensional pattern that comprises one or more distinctive features located at a determined depth, a determined width, a determined orientation, or combinations thereof, in the at least one scintillator.

20. The method of claim 19, further comprising identifying a three-dimensional spatial location at which scintillation light emitted from the at least one scintillator is generated based on the one or more distinctive features.
